(19) United States
(12) Patent Application Publication
(10) Pub. No.: US 2019/0077948 A1
(43) Pub. Date: Mar. 14, 2019

(54) THERMOPLASTIC MOULDING COMPOUND BASED ON VINYLAROMATIC COPOLYMERS FOR 3D PRINTING

(71) Applicant: INEOS STYROLUTION GROUP GMBH, Frankfurt am Main (DE)

(72) Inventors: Stephanie BAUMANN, Wuerzburg (DE); Frank EISENTRAEGER, Koeln (DE); Josef MEINERS, Krefeld (DE); Norbert NIESSNER, Friedelsheim (DE); Hans-Werner SCHMIDT, Bayreuth (DE)

(21) Appl. No.: 16/084,354

(22) PCT Filed: Mar. 16, 2017
(86) PCT No.: PCT/EP2017/056212

§ 371 Date: Sep. 12, 2018

(30) Foreign Application Priority Data
Mar. 17, 2016 (EP) 16160891.4

(51) Int. Cl. C08L 25/12; C08L 55/02; C08K 5/20; C08K 5/098

(52) U.S. Cl. CPC C08L 25/12; C08L 55/02; B33Y 70/00; C08K 5/098; C08K 5/20

(57) ABSTRACT

A thermoplastic molding composition can be employed for 3D printing if it comprises:
A: 92.9 to 98.59 wt % of impact-modified polymer A, consisting of:
   40 to 90 wt % of vinylaromatic copolymer a,
   10 to 60 wt % of ABS graft copolymer b;
B1: 1.2 to 3.5 wt % of amide or amide derivative of saturated higher fatty acid having 14 to 22 carbon atoms;
B2: 0.2 to 0.6 wt % of salt of saturated higher fatty acid having 14 to 22 carbon atoms; and
C: 0.01 to 3 wt % of auxiliaries C such as stabilizers, oxidation retarders, agents against heat and UV light decomposition.

The invention relates to thermoplastic molding compositions based on vinylaromatic copolymers with enhanced toughness/viscosity balance for 3D printing, and also to the use of the aforesaid molding compositions for 3D printing and also for producing filaments with high dimensional stability for 3D printing.

The use of amorphous thermoplastics for 3D printing, especially of acrylonitrile-butadiene-styrene (ABS), is known. EP-A 1015215, for instance, describes a method for producing a three-dimensional object of predetermined shape from a material which can be consolidated thermally. For the 3D printing, the material is first fluidized and extruded, and a plurality of layers of the material are applied to a support, with movement, and then the shaped material is consolidated by cooling to below the solidification temperature of the material. Thermally consolidable material used comprises amorphous thermoplastics, especially acrylonitrile-butadiene-styrene (ABS).

EP-A 1087862 describes a rapid prototyping system for producing a three-dimensional article by extrusion and application of solidifiable thermoplastic modeling and support material in a plurality of layers. The thermoplastic material is supplied via a spool. ABS is cited as a suitable modelable material. As fragmentary support material, which is removed following completion of the 3D model, a mixture of ABS and a polystyrene copolymer as filling material with a fraction of up to 80% is used.

EP-A 1497093 describes a method for producing a prototype of a plastics injection molding from a thermoplastic material, which in fluidized form is injected into a mold until it fills the cavity of said mold and, after curing, forms the prototype. This prototype is produced via “Fused Deposition Modeling”, a specific 3D printing method. The thermoplastic material is selected from: ABS, polycarbonate, polystyrene, acrylates, amorphous polyamides, polyesters, PPS, PPE, PEEK, PEAK, and mixtures thereof, with ABS being preferred. Contraction phenomena are avoided using preferably amorphous thermoplastics.

US 2008/0071030 describes a thermoplastic material which is used for producing three-dimensional models by multilayer deposition.

The thermoplastic material comprises a base polymer selected from the group consisting of: polyethersulfones, polyetherimides, polyphenylsulfones, polyphenylenes, polycarbonates, polysulfones, polystyrenes, acrylates, amorphous polyamides, polyesters, nylon, polyetheretherketones, and ABS, and 0.5 to 10 wt % of a silicone release agent. Preference as base polymer is given to using polyethersulfone and mixtures thereof with polystyrene (3 to 8 wt %). In order to avoid contraction, preference is given to using amorphous polymers and optionally customary filling materials.

US 2009/0295032 proposes modified ABS materials for 3D printing. The ABS materials are modified by additional monomers, oligomers or polymers, more particularly acrylates. Given as an example are MMA-modified ABS/poly(styrene-acrylonitrile) blends, more particularly CYCOLAC ABS MG 94. The proportions of the components and the viscosity of the blends are not specified. The aforementioned materials, however, are often too brittle for 3D printing, and are deserving of improvement in relation both to toughness and to their odor. With the materials of the prior art, furthermore, the viscosity, under the conditions of the melt flow index at low shear rates, is often too high and is likewise deserving of improvement.

WO 2015/091817 discloses thermoplastic molding compositions for 3D printing that have improved toughness/viscosity balance and are based on impact-modified vinylaromatic copolymers, especially styrene-acrylonitrile (SAN) copolymers. Preferred for use as impact modifier are ABS graft rubbers. To produce filaments with high dimensional stability for 3D printing, the aforesaid molding compositions may include customary additives and/or auxiliaries such as stabilizers, oxidation retarders, agents against thermal decomposition and decomposition due to ultraviolet light, lubricants and mold release agents, colorants such as dyes and pigments, fibrous and pulverulent fillers and reinforcing agents, nucleating agents, plasticizers, and so on, in amounts of preferably 0.1 to 30 wt %, more preferably 0.1 to 10 wt %. Examples of suitable lubricants and mold release agents are long-chain fatty acids such as stearic acid or behenic acid, their salts (e.g., Ca or Zn stearate) or esters (e.g., stearyl stearate or pentaerythritol tetrastearate), and also amide derivatives (e.g., ethylenebisstearylamide), which can be used in amounts up to 1 wt %. There are no examples of this.

Many of the aforementioned molding compositions are not suitable, or are at least deserving of improvement, for the production of filaments for 3D printing, owing to their inadequate quality and/or dimensional stability.

It is an object of the present invention to provide improved, low-odor thermoplastic materials (molding compositions) for 3D printing, which are also suitable for producing filaments of high dimensional stability for 3D printing while retaining their mechanical properties. The object has been achieved by means of the addition of a specific lubricant and mold release agent combination.

One subject of the invention is a thermoplastic molding composition for 3D printing, comprising (consisting of) a mixture of the components A, B1, B2, and C:
A: 92.9 to 98.59 wt % of at least one impact-modified polymer A, consisting of the components a and b:
   a: 40 to 90 wt % of at least one vinylaromatic copolymer a having an average molar mass Mw of 150 000 to 360 000 g/mol, selected from the group consisting of: styrene-acrylonitrile copolymers, α-methylstyrene-acrylonitrile copolymers, styrene-maleic anhydride copolymers, styrene-phenylmaleimide copolymers, styrene-methyl methacrylate copolymers, styrene-acrylonitrile-maleic anhydride copolymers, styrene-acrylonitrile-phenylmaleimide copolymers, α-methylstyrene-acrylonitrile-methyl methacrylate copolymers, α-methylstyrene-acrylonitrile-tert-butyl methacrylate copolymers, and styrene-acrylonitrile-tert-butyl methacrylate copolymers, more particularly styrene-acrylonitrile copolymers;
   b: 10 to 60 wt % of at least one graft copolymer b as impact modifier, consisting of, based on b:
   b1: 20 to 90 wt % of a graft base b1, obtained by polymerization of:
      b11: 70 to 100 wt % of at least one conjugated diene;
      b12: 0 to 30 wt % of at least one further comonomer selected from: styrene, α-methylstyrene, acrylonitrile, methacrylonitrile, MMA, MAn, and N-phenylmaleimide (N-PMI);
      b13: 0 to 10 wt % of one or more polyfunctional, crosslinking monomers;
   b2: 10 to 80 wt % of a graft b2, obtained by polymerization of:
      b21: 65 to 95 wt %, preferably 70 to 90 wt %, more particularly 72.5 to 85 wt %, more preferably 75 to 85 wt %, of at least one vinylaromatic monomer, preferably styrene and/or α-methylstyrene, more particularly styrene;
      b22: 5 to 35 wt %, preferably 10 to 30 wt %, more particularly 15 to 27.5 wt %, often more preferably 15 to 25 wt %, of acrylonitrile and/or methacrylonitrile, preferably acrylonitrile;
      b23: 0 to 30 wt %, preferably 0 to 20 wt %, more preferably 0 to 15 wt %, of at least one further monoethylenically unsaturated monomer selected from: MMA, MAn, and N-PMI;
      where the sum of a and b makes 100 wt %,
B1: 1.2 to 3.5 wt % of at least one, preferably one, amide or amide derivative of at least one saturated higher fatty acid having 14 to 22, preferably 16 to 20, carbon atoms, preferably of an amide or amide derivative of stearic or behenic acid, more preferably ethylenebisstearylamide;
B2: 0.2 to 0.6 wt % of at least one, preferably one, salt of a saturated higher fatty acid having 14 to 22, preferably 16 to 20, carbon atoms preferably a calcium, magnesium or zinc salt of stearic or behenic acid, more preferably magnesium stearate;
C: 0.01 to 3 wt % of one or more auxiliaries C selected from the group consisting of: stabilizers, oxidation retarders, and agents against thermal decomposition and decomposition by ultraviolet light;
   where the sum of components A, B1, B2, and C makes 100 wt %.

In general the viscosity (measured to ISO 11443:2014) of the molding composition of the invention at shear rates of 1 to 10 l/s and at temperatures of 250° C. is not more than 1×10⁵ Pa*s and the melt volume rate (MVR, measured to ISO 1133-1:2011 at 220° C. and 10 kg load) is more than 6 ml/10 min.

The sum of the amounts in wt % of components b11, b12, and optionally b13, and also the sum of the amounts in wt % of components b21 and b22, always make 100 wt %.

The weight-average molar mass Mw is determined by GPC (solvent: tetrahydrofuran, polystyrene as polymer standard) with UV detection (DIN EN 150 16014-5:2012-10).

The thermoplastic molding composition used in accordance with the invention may optionally comprise, as component D, one or more customary additives and/or auxiliaries D, different from the components B1, B2, and C, such as colorants, dyes and pigments, fibrous and pulverulent fillers and reinforcing agents, nucleating agents, processing assistants, plasticizers, flame retarders, etc.

The fraction thereof is generally not more than 30 parts by weight, preferably not more than 20 parts by weight, more preferably not more than 10 parts by weight, based on 100 parts by weight of the molding composition composed of the components A, B1, B2, and C.

Component D is not a lubricant and mold release assistant.

Preference is given to a molding composition of the invention consisting of a mixture of components A, B1, B2, and C.

For the purposes of the present invention, 3D printing means the production of three-dimensional moldings with the aid of an apparatus (3D printer) suitable for 3D printing. The 3D printer used in accordance with the invention is more particularly a 3D printer which is suitable for the fused deposition modeling (FDM) method.

The FDM method is a fusion layering method wherein filaments of a molding composition suitable for 3D printing are fluidized by heating in the 3D printer, after which the fluidized molding composition is applied layer by layer to a moving construction platform (printing bed) or to a previous layer of the molding composition, by extrusion with a heating nozzle which is freely movable within the fabrication plane, and then the shaped material is consolidated, optionally by cooling.

Preference is given to a molding composition of the invention as described above, comprising (consisting of):

93.5 to 98.2 wt % of component A,
1.5 to 3.0 wt % of component B1,
0.25 to 0.5 wt % of component B2, and
0.05 to 3 wt % of component C.

Particular preference is given to a molding composition of the invention as described above, comprising (consisting of):

95.1 to 97.95 wt % of component A,
1.7 to 2.5 wt % of component B1,
0.3 to 0.4 wt % of component B2, and
0.05 to 2 wt % of component C.

With further preference, the molding composition of the invention comprises substantially amorphous polymers, meaning that at least half (at least 50 wt %) of the polymers present in the molding composition are amorphous polymers.

### Impact-Modified Polymer A (Component A)

In the impact-modified polymer A, the fraction of component a is preferably 50 to 88 wt % and the fraction of the impact modifier b is preferably 50 to 12 wt %. More preferably, in the polymer mixture A, the fraction of the polymer a is 55 to 85 wt % and the fraction of the impact modifier b is 45 to 15 wt %. Very preferably, in the polymer mixture A, the fraction of the polymer a is 65 to 85 wt % and the fraction of the impact modifier b is 35 to 15 wt %.

### Vinylaromatic Copolymer a

Vinylaromatic copolymer a forms a hard phase with a glass transition temperature Tg of >20° C.

The weight-average molar masses Mw of the polymers a are customarily 150 000 to 360 000 g/mol, preferably 150 000 to 300 000 g/mol, more preferably 150 000 to 270 000 g/mol, very preferably 150 000 to 250 000 g/mol, more particularly 150 000 to 220 000 g/mol.

Employed as vinylaromatic copolymer a in accordance with the invention are vinylaromatic copolymers selected from the group consisting of: styrene-acrylonitrile copolymers, α-methylstyrene-acrylonitrile copolymers, styrene-maleic anhydride copolymers, styrene-phenylmaleimide copolymers, styrene-methyl methacrylate copolymers, styrene-acrylonitrile-maleic anhydride copolymers, styrene-acrylonitrile-phenylmaleimide copolymers, α-methylstyrene-acrylonitrile-methyl methacrylate copolymers, α-methylstyrene-acrylonitrile-tert-butyl methacrylate copolymers, and styrene-acrylonitrile-tert-butyl methacrylate copolymers.

The aforementioned vinylaromatic copolymers a are preferably amorphous polymers.

Used as preference as vinylaromatic copolymer a are styrene-acrylonitrile copolymers (SAN) and α-methylstyrene-acrylonitrile copolymers (AMSAN), especially styrene-acrylonitrile copolymers.

SAN copolymers and α-methylstyrene-acrylonitrile copolymers (AMSAN) used as vinylaromatic copolymer a in accordance with the invention are obtainable by polymerization of in general 18 to 35 wt %, preferably 20 to 35 wt %, more preferably 22 to 35 wt % of acrylonitrile (AN) and 82 to 65 wt %, preferably 80 to 65 wt %, more preferably 78 to 65 wt % of styrene (S) and/or α-methylstyrene (AMS), where the sum of styrene and/or α-methylstyrene and acrylonitrile makes 100 wt %. Particularly preferred are SAN copolymers a of the aforesaid composition.

The SAN and AMSAN copolymers used generally have an average molar mass Mw of 150 000 to 350 000 g/mol, preferably 150 000 to 300 000 g/mol, more preferably 150 000 to 250 000 g/mol, and very preferably 150 000 to 200 000 g/mol.

SMMA copolymers used as vinylaromatic copolymer a in accordance with the invention are obtainable by polymerizing generally 18 to 50 wt %, preferably 20 to 30 wt %, of methyl methacrylate (MMA), and 50 to 82 wt %, preferably 80 to 70 wt %, of styrene, where the sum of styrene and MMA makes 100 wt %.

SMSA copolymers used as polymer a in accordance with the invention are obtainable by polymerizing generally 10 to 40 wt %, preferably 20 to 30 wt %, of maleic anhydride (MAn), and 60 to 90 wt %, preferably 80 to 70 wt %, of styrene, where the sum of styrene and MAn makes 100 wt %.

The vinylaromatic copolymer a has a viscosity number VN (determined to DIN 53 726 at 25° C. on a 0.5 wt % strength solution of the polymer a in dimethylformamide) of 50 to 120, preferably 52 to 100, and more preferably 55 to 80 ml/g. The vinylaromatic copolymers a are obtained in a known way by bulk, solution, suspension, precipitation or emulsion polymerization, with bulk and solution polymerization being preferred. Details of these processes are described for example in Kunststoffhandbuch, edited by R. Vieweg and G. Daumiller, volume 4 “Polystyrol”, Carl-Hanser-Verlag Munich 1996, p. 104 ff, and also in “Modern Styrenic Polymers: Polystyrenes and Styrenic Copolymers” (Eds., J. Scheirs, D. Priddy, Wiley, Chichester, UK, (2003), pages 27 to 29) and in GB-A 1472195.

Suitable SAN copolymers are commercial SAN copolymers such as Luran® from Ineos Styrolution (Frankfurt), for example. Preferred SAN copolymers are those having an S/AN ratio (in weight percent) of 81/19 to 67/33 and an MVR (measured to ISO 1133 at 220° C. and 10 kg load) of at least 10 ml/10 min such as Luran 368, for example.

Further preferred are SAN copolymers having an S/AN ratio (in weight percent) of 81/19 to 65/35 and an MVR (measured to ISO 1133 at 220° C. and 10 kg load) of at least 8 ml/10 min such as Luran M60, Luran VLL1970, Luran 25100, Luran VLP, and Luran VLR, for example; particularly preferred among the aforementioned SAN copolymers are those having an MVR of at least 10 ml/10 min.

### Graft Copolymer b (Impact Modifier)

The graft copolymer b used in accordance with the invention forms a soft phase having a glass transition temperature Tg of <0° C., preferably <−20° C., more preferably <−40° C.

The particle size of the graft copolymer or impact modifier b used in accordance with the invention is generally at least 50 nm and at most 10 μm, preferably 60 nm to 5 μm, more preferably 80 nm to 3 μm, very preferably 80 nm to 2 μm.

The particle size here refers to the average particle diameter d₅₀.

The average particle diameter d₅₀ can be determined via ultracentrifuge measurement (cf. W. Scholtan, H. Lange: Kolloid Z. u. Z. Polymere 250, pp. 782 to 796 (1972)).

One particular embodiment uses graft copolymers or impact modifiers b with bimodal, trimodal or multimodal particle size distributions.

Used in accordance with the invention is at least one graft copolymer b as impact modifier, with b1: 20 to 90 wt %, preferably 40 to 90 wt %, more preferably 45 to 85 wt %, very preferably 50 to 80 wt %, of a graft base b1, obtained by polymerization of:
b11: 70 to 100 wt %, preferably 75 to 100 wt %, more preferably 80 to 100 wt %, of at least one conjugated diene, more particularly butadiene,
b12: 0 to 30 wt %, preferably 0 to 25 wt %, more preferably 0 to 20 wt %, of at least one further comonomer selected from: styrene, α-methylstyrene, acrylonitrile, methacrylonitrile, MMA, MAn, and N-phenylmaleimide (N-PMI), preferably styrene and α-methylstyrene, more preferably styrene;
b13: 0 to 10 wt %, preferably 0.01 to 5, more preferably 0.02 to 2 wt %, of one or more polyfunctional, crosslinking monomers,
   b2: 10 to 80 wt %, preferably 10 to 60, more preferably 15 to 55 wt %, very preferably 20 to 50 wt %, of a graft, obtained by polymerization of:
b21: 65 to 95 wt %, preferably 70 to 90 wt %, more particularly 72.5 to 85 wt %, often more preferably 75 to 85 wt % of at least one vinylaromatic monomer, preferably styrene and/or α-methylstyrene, more particularly styrene;
b22: 5 to 35 wt %, preferably 10 to 30 wt %, more particularly 15 to 27.5 wt %, often more preferably 15 to 25 wt % of acrylonitrile and/or methacrylonitrile, preferably acrylonitrile,
b23: 0 to 30 wt %, preferably 0 to 20 wt %, more preferably 0 to 15 wt % of at least one further monoethylenically unsaturated monomer selected from: MMA, MAn, and N-PMI, preferably MMA.

Conjugated dienes b11 contemplated are dienes having 4 to 8 carbon atoms such as butadiene, isoprene, piperylene, and chloroprene or mixtures thereof. Preference is given to using butadiene or isoprene or mixtures thereof, very preferably butadiene.

Diene rubbers b1 are, for example, homopolymers of the aforementioned conjugated dienes b11, copolymers of such dienes b11 with one another, copolymers of such dienes with acrylates b11, more particularly n-butyl acrylate, and copolymers of such dienes with the comonomers b12 selected from styrene, α-methylstyrene, acrylonitrile, methacrylonitrile, methyl methacrylate (MMA), maleic anhydride (MAn), and N-phenylmaleimide (N-PMI).

Preferred diene rubbers are commercial butadiene, butadiene-styrene, butadiene-methyl methacrylate, butadiene-n-butyl acrylate, butadiene-acrylonitrile, and acryloni-trile-butadiene-styrene rubbers (ABS); particularly preferred are ABS rubbers; especially preferred for use as diene rubber b1 is a butadiene rubber.

Crosslinking monomers b13 are monomers which contain two or more double bonds capable of copolymerization, such as ethylene glycol diacrylate, butanediol diacrylate, hexanediol diacrylate, ethylene glycol dimethacrylate, butanediol dimethacrylate, hexanediol dimethacrylate, divinylbenzene, diallyl maleate, diallyl fumarate, diallyl phthalate, diallyl cyanurate, trisallyl cyanurate, esters of tricyclodecenyl alcohol such as tricyclodecenyl acrylate, dihydrodicyclopentadienyl acrylate, diallyl phosphate, allyl acrylate, allyl methacrylate, and dicyclopentadienyl acrylate (DCPA). Preference is given to using esters of tricyclodecenyl alcohol, divinylbenzene, allyl (meth)acrylate and/or trisallyl cyanurate.

With preference no crosslinking monomers b13 are used.

The aforementioned graft copolymers or impact modifiers b are preferably acrylonitrile-butadiene-styrene (ABS) impact modifiers.

The impact modifier b used in accordance with the invention is more preferably an ABS impact modifier b with

b1: 40 to 90 wt % of a graft base b1, obtained by polymerization of:
b11: 70 to 100 wt %, preferably 90 to 100 wt %, often preferably 90 to 99.9 wt %, often more preferably 90 to 99 wt %, of butadiene,
b12: 0 to 30 wt %, preferably 0 to 10 wt %, often preferably 0.1 to 10 wt %, often more preferably 1 to 10 wt %, of styrene, and
   b2: 10 to 60 wt % of a graft b2, obtained by polymerization of:
b21: 65 to 95 wt %, preferably 70 to 90 wt %, more particularly 72.5 to 85 wt % of styrene, and
b22: 5 to 35 wt %, preferably 10 to 30 wt %, more particularly 15 to 27.5 wt %, of acrylonitrile.

Especially preferred are aforesaid ABS impact modifiers with

b1: 40 to 90 wt % of a graft base b1, obtained by polymerization of:
b11: 100 wt % of butadiene, and
   b2: 10 to 60 wt % of a graft b2, obtained by polymerization of:
b21: 70 to 90 wt %, more particularly 72.5 to 85 wt %, of styrene, and
b22: 10 to 30 wt %, more particularly 15 to 27.5 wt %, of acrylonitrile.

Preferred diene rubbers b1 and ABS impact modifiers b of these kinds are described in EP 0 993 476 B1. Particularly preferred diene rubbers b1 and ABS impact modifiers b are described in publication WO 01/62848.

The soft component is preferably a copolymer of multistage construction (“core/shell morphology”). For example, an elastomeric core (glass transition temperature Tg <50° C.) may be enveloped by a “hard” shell (polymers with Tg >50° C.), or vice versa. Core/shell graft copolymers of such kinds are known.

Methods for producing the impact modifiers b are known to the skilled person and described in the literature. Some corresponding products are available commercially. Preparation by emulsion polymerization has proven particularly advantageous (EP-B 0 993 476 and WO 01/62848).

Polymerization is carried out customarily at 20 to 100° C., preferably 30 to 80° C. In general, customary emulsifiers are used as well, examples being alkali metal salts of alkylsulfonic or alkylarylsulfonic acids, or alkyl sulfates, fatty alcohol sulfonates, salts of higher fatty acids having 10 to 30 carbon atoms, sulfosuccinates, ethersulfonates, or resin soaps. Preference is given to taking the alkali metal salts, more particularly the Na and K salts, of alkylsulfonates or fatty acids having 10 to 18 carbon atoms.

In general the emulsifiers are used in amounts of 0.5 to 5 wt %, more particularly of 0.5 to 3 wt %, based on the monomers used in the preparation of the graft base b1.

The dispersion is preferably prepared using water in an amount such that the completed dispersion has a solids content of 20 to 50 wt %. It is usual to operate at a water/monomer ratio of 2:1 to 0.7:1.

Radical initiators suitable for initiating the polymerization reaction are all those which decompose at the selected reaction temperature, in other words not only those which decompose by heat alone but also those which do so in the presence of a redox system. Polymerization initiators contemplated are preferably radical initiators, examples being peroxides such as preferably peroxosulfates (for instance, sodium or potassium persulfate), and azo compounds such as azodiisobutyronitrile. It is, though, also possible to use redox systems, especially those based on hydroperoxides such as cumene hydroperoxide.

The polymerization initiators are used generally in an amount of 0.1 to 1 wt %, based on the graft base monomers b11) and b12).

The radical initiators and the emulsifiers too are added to the reaction mixture, for example, discontinuously as the total amount at the start of the reaction, or divided into a plurality of portions, batchwise, at the start and at one or more later times, or continuously, over a defined time interval.

Continuous addition may also take place along a gradient, which may for example be ascending or descending, linear or exponential, or else staged (step function).

Furthermore, accompanying use may be made of chain transfer agents such as, for example, ethylhexyl thioglycolate, n- or tert-dodecyl mercaptan or other mercaptans, terpinols, and dimeric alpha-methylstyrene, or other compounds suitable for regulating the molecular weight. The chain transfer agents are added continuously or discontinuously to the reaction mixture, as described above for the radical initiators and emulsifiers.

In order to maintain a constant pH, situated preferably at 6 to 9, it is possible for buffer substances to be used such as Na₂HPO₄/NaH₂PO₄, sodium hydrogencarbonate, or buffers based on citric acid/citrate. Chain transfer agents and buffer substances are used in the customary amounts, and so further details are unnecessary.

In one particularly preferred embodiment, a reducing agent is added during the grafting of the graft base b1 with the monomers b21) to b23).

The graft base b1, in one particular embodiment, may also be prepared by polymerizing the monomers b11) to b13) in the presence of a finely divided latex (“seed latex mode” of polymerization). This latex is included in the initial charge and may consist of monomers that form rubber-elastic polymers, or else of other monomers, as already stated. Suitable seed latices consist for example of polybutadiene or polystyrene.

In the case of the seed polymerization technique, it is usual first to prepare a finely divided polymer, preferably a polybutadiene, as seed latex and then to continue polymerization by ongoing reaction with butadiene-containing monomers to form larger particles (see, for example, Houben Weyl, Methoden der Organischen Chemie, Makromolekulare Stoffe [Macromolecular compounds] Part 1, p. 339 (1961), Thieme Verlag Stuttgart). Operation in this case is carried out preferably using the seed batch method or the seed feed method.

Through the use of seed latices—especially polybutadiene seed latices—having an average particle diameter d₅₀ of 25 to 200 nm, preferably of 30 to 180 nm, and more preferably of 60 to 170 nm, polybutadiene latices b1 having an average particle diameter d₅₀ of 200 to 600 nm, preferably 230 to 480 nm, more preferably of 240 to 470 nm, very preferably of 250 to 460 nm, can be obtained.

Where seed latices are used that have average particle diameters d₅₀ of more than 80 nm, preferably more than 90 nm, and more preferably more than 100 nm, the seed latices themselves are also prepared preferably by seed polymerization. This is done using preferably seed latices having average particle diameters d₅₀ of 10 to 60 nm, preferably 20 to 50 nm.

Preferred graft bases b1 and graft copolymers and/or impact modifiers b can be obtained by the seed polymerization technique described in document WO 01/62848A1.

In another preferred embodiment, the graft base b1 may be prepared by what is called a feed process. With this process, a certain fraction of the monomers b11) to b13) is introduced as an initial charge and the polymerization is initiated, after which the remainder of the monomers b11) to b13) (“feed fraction”) are added as a feed during the polymerization.

The feed parameters (gradient design, quantity, duration, etc.) are dependent on the other polymerization conditions. Here as well, mutatis mutandis, the observations apply that were made in relation to the mode of addition of the radical initiator and the emulsifier. With the feed process, the fraction of the monomers b11) to b13) that is included in the initial charge is preferably 5 to 50 wt %, more preferably 8 to 40 wt %, based on b1. The feed fraction of b11) to b13) is run in preferably over the course of 1-18 hours, more particularly 2-16 hours, especially 4 to 12 hours.

Also suitable, furthermore, are graft polymers having a plurality of “soft” and “hard” shells, with a construction, for example, of b1) -b2) -b1) -b2), or b2) -b1) -b2), especially in the case of relatively large particles.

The precise polymerization conditions, particularly the nature, quantity, and metering of the emulsifier and of the other polymerization auxiliaries, are preferably selected such that the resulting graft copolymer latex, i.e., the impact modifier b, has an average particle size, defined by the d₅₀ value of the particle size distribution, of 80 to 1000 nm, preferably 85 to 600 nm, and more preferably 90 to 500 nm.

The polymerization conditions may also be harmonized with one another such that the polymer particles have a bimodal particle size distribution, in other words a size distribution having two more or less pronounced maxima. The first maximum is more significantly pronounced (comparatively narrow peak) than the second, and is situated in general at 25 to 200 nm, preferably 60 to 170 nm, more preferably 70 to 150 nm. The second maximum is comparatively broad and is situated in general at 150 to 800 nm, preferably 180 to 700 nm, more preferably 200 to 600 nm.

The second maximum (150 to 800 nm) here is situated at larger particle sizes than the first maximum (25 to 200 nm).

Often, in the case of a bimodal particle size distribution, the first maximum (b1′) of the graft base b1 is situated at an average particle size d₅₀ of 25 to 200 nm, preferably 30 to 180 nm, more preferably 60 to 170 nm, and the second maximum (b1″) of the graft base b1 is situated at an average particle size d₅₀ of 230 to 480 nm, very preferably 240 to 470 nm, especially preferably 250 to 460 nm.

According to another embodiment, the particle size distribution of the graft base b1 is trimodal: the first maximum (b1′) of the graft base b1 is situated at an average particle size d₅₀ of 25 to 200 nm, preferably 30 to 180 nm, more preferably 60 to 170 nm, and the second maximum (b1″) of the graft base b1 is situated at an average particle diameter d₅₀ of 230 to 330 nm, preferably of 240 to 320 nm, and more preferably of 250 to 310 nm, and the third maximum (b1′″) possesses an average particle diameter d₅₀ of 340 to 480 nm, preferably of 350 to 470 nm, and more preferably of 360 to 460 nm.

The bimodal particle size distribution is obtained preferably by means of (partial) agglomeration of the polymer particles. The approach taken for this may be as follows, for example: the monomers b11) to b13), which construct the core, are polymerized to a conversion of customarily at least 90%, preferably greater than 95%, based on the monomers used. This conversion is generally reached after 4 to 20 hours. The resulting rubber latex has an average particle size d₅₀ of at most 200 nm and a narrow particle size distribution (virtually monodisperse system).

In the second stage, the rubber latex is agglomerated. This is generally done by adding a dispersion of an acrylic ester polymer. Preference is given to using dispersions of copolymers of C1-C4 alkyl esters of acrylic acid, preferably of ethyl acrylate, with 0.1 to 10 wt % of monomers that form polar polymers, such as acrylic acid, methacrylic acid, acrylamide or methacrylamide, N-methylolmethacrylamide or N-vinylpyrrolidone, for example. Particularly preferred is a copolymer of 96% ethyl acrylate and 4% methacrylamide. The agglomerating dispersion may optionally also comprise two or more of the stated acrylic ester polymers.

The concentration of the acrylic ester polymers in the dispersion used for the agglomeration is in general to be between 3 and 40 wt %. In the agglomeration, 0.2 to 20, preferably 1 to 5, parts by weight of the agglomerating dispersion are used per 100 parts of the rubber latex, calculated in each case on solids. The agglomeration is carried out by adding the agglomerating dispersion to the rubber. The rate of addition is normally not critical, with addition lasting generally for about 1 to 30 minutes at a temperature between 20 and 90° C., preferably between 30 and 75° C.

Apart from by means of an acrylic ester polymer dispersion, the rubber latex may also be agglomerated by other agglomerating agents such as acetic anhydride, for example.

Also possible is agglomeration by pressure or freezing (pressure or freeze agglomeration). The methods stated are known to the skilled person.

Under the conditions stated, only some of the rubber particles are agglomerated, producing a bimodal distribution. After the agglomeration here, generally more than 50%, preferably between 75 and 95% of the particles (numerical distribution) are present in the unagglomerated state. The partly agglomerated rubber latex obtained is comparatively stable, and so it can readily be stored and transported without coagulation occurring.

In order to obtain a bimodal particle size distribution of the graft copolymer b, it is also possible to prepare two different graft polymers b′ and b″, which differ in their average particle size, in a customary way separately from one another, and to combine the graft copolymers b′ and b″ in the desired quantitative ratio. This variant is preferred in accordance with the invention.

In order to obtain a trimodal particle size distribution of the graft copolymer b, it is also possible to carry out conventional preparation of two different graft bases b1′ and b1″, differing in their average particle size, separately from one another, to combine the graft bases in the desired ratio prior to grafting (or else, optionally, afterward), and then to graft on the graft and subsequently to add, in the desired quantitative ratio, a third, separately prepared, graft copolymer b″ to the resultant graft copolymers b′ and b″, this copolymer b′″ differing from b′ and b″ in terms of its average particle size.

The aforementioned graft copolymer b is often a mixture of different ABS graft polymers b′ and b″ or b′, b″, and b′″.

In the case of a bimodal particle size distribution, the impact modifier b is preferably a mixture of ABS graft copolymers b′ and b″, with the graft base b1′ of the ABS graft copolymer b′ customarily having an average particle size d₅₀ of 25 to 200 nm, preferably 30 to 180 nm, more preferably 60 to 170 nm, and the graft base b1″ of the ABS graft copolymer b″ possessing an average particle size d₅₀ of 230 to 480 nm, very preferably 240 to 470 nm, especially preferably 250 to 460 nm.

The impact modifier b in the case of a trimodal particle size distribution preferably is a mixture of ABS graft copolymers b′, b″, and b′″, with the graft base b1′ of the ABS graft copolymer b′ having an average particle diameter d₅₀ of 25 to 200 nm, preferably 30 to 180 nm, more preferably 60 to 170 nm, the graft base b1″ of the ABS graft copolymer b″ having an average particle diameter d₅₀ of 230 to 330 nm, preferably of 240 to 320 nm, and more preferably of 250 to 310 nm, and the graft base b1′″ of the ABS graft copolymer b′″ possessing an average particle diameter d₅₀ of 340 to 480 nm, preferably of 350 to 470 nm, and more preferably of 360 to 460 nm.

The graft bases b1′, b1″, and b1′″ are preferably butadiene homopolymers and the respective graft b2 is preferably a SAN copolymer.

The graft copolymers b′, b″, and b′″ are used in a graft copolymer b′: sum of the graft copolymers b″ and b′″ ratio by weight of generally 75:25 to 50:50, preferably 70:30 to 55:45, more preferably 65:35 to 57:43, more particularly 60:40.

Particularly preferred is a mixture of aforementioned graft copolymers b′ and b″ or b′, b″, and b′″ in which the respective graft base b1′ and b1″ or b1′, b1″, and b1′″ has been prepared by seed polymerization.

The graft base b1″ generally has an average particle diameter d₅₀ of 230 to 330 nm, preferably of 240 to 320 nm, and more preferably of 250 to 310 nm.

The gel content of b1″ is generally 30 to 80 wt %, preferably 40 to 75 wt %, and more preferably 45 to 70 wt %.

The graft base b1′″ generally has an average particle diameter d₅₀ of 340 to 480 nm, preferably of 350 to 470 nm, and more preferably of 360 to 460 nm.

The gel content of b1′″ is generally 50 to 95 wt %, preferably 55 to 90 wt %, and more preferably 60 to 85 wt %.

Very preferably the seed polymerization of the graft base of the graft bases b1″ and b1′″ takes place using at least one polybutadiene seed latex having an average particle diameter d₅₀ of 25 to 200 nm, preferably of 30 to 180 nm, and more preferably of 60 to 170 nm.

The graft base b1′ generally possesses an average particle diameter d₅₀ of 25 to 200 nm, preferably 30 to 180 nm, more preferably 60 to 170 nm.

Very preferably the seed polymerization of the graft base b1′ takes place using at least one polybutadiene seed latex having an average particle diameter d₅₀ of 10 to 60 nm, preferably 20 to 50 nm.

The gel content of the graft base b1′ is 30 to 98 wt %, preferably 40 to 95 wt %, and more preferably 50 to 92 wt %.

The average particle diameter d₅₀ can be determined by ultracentrifuge measurement (cf. W. Scholtan, H. Lange: Kolloid Z. u. Z. Polymere 250, pp. 782 to 796 (1972)); the values reported for the gel content are based on determination via the wire cage method in toluene (cf. Houben-Weyl, Methoden der Organischen Chemie, Makromolekulare Stoffe [Macromolecular Compounds], part 1, p. 307 (1961), Thieme Verlag Stuttgart).

The gel contents can be adjusted in a manner known in principle through application of suitable reaction conditions (e.g., high reaction temperature and/or polymerization to a high conversion, and, optionally, addition of crosslinking substances to obtain a high gel content, or, for example, low reaction temperature and/or termination of the polymerization reaction prior to excessive crosslinking, and also, optionally, addition of chain transfer agents, to achieve a low gel content).

Mixtures of the aforementioned graft copolymers b′, b″, and b′″ used in accordance with the invention, and the preparation of the graft bases thereof by seed polymerization, are described in WO 01/62848.

Through the choice of the reaction conditions, the polymerization of the graft base b1 is customarily conducted in such a way as to result in a graft base having a defined crosslinking state. Examples of parameters essential for this are the reaction temperature and reaction time, the ratio of monomers, chain transfer agents, radical initiators, and, in the case of the feed process, for example, the feed rate and the amount and timing of addition of chain transfer agent and initiator.

One method for characterizing the state of crosslinking of crosslinked polymer particles is the measurement of the swelling index SI, which is a measure of the swellability by a solvent of a polymer with greater or lesser crosslinking. Examples of customary swelling agents are methyl ethyl ketone or toluene. The SI of the molding compositions of the invention is situated customarily in the SI=10 to 60 range, preferably 15 to 55, and more preferably 20 to 50.

Another method for characterizing the state of crosslinking is to measure NMR relaxation times of the mobile protons, referred to as T2 times. The greater the crosslinking of a particular network, the lower its T2 times. Customary T2 times for the graft bases b1 of the invention are T2 times in the 2.0 to 4.5 ms range, preferably 2.5 to 4.0 ms, and more preferably 2.5 to 3.8 ms, measured on filmed samples at 80° C.

A further measure for characterizing the graft base and the state of crosslinking thereof is the gel content, in other words that fraction of the product that is crosslinked and is therefore not soluble in a particular solvent. Rationally, the gel content is determined in the same solvent as the swelling index.

Customary gel contents of the graft bases b1 of the invention are in the 50 to 90% range, preferably 55 to 85%, and more preferably 60 to 80%.

With the mixtures of graft bases b1′, b1″, and b1′″ with trimodal particle size distribution, these being used preferably in accordance with the invention, the individual gel contents are within the ranges described earlier on above.

The swelling index is determined, for example, by the following method: around 0.2 g of the solids of a graft base dispersion filmed by evaporation of water are swollen in a sufficient amount (e.g., 50 g) of toluene. After 24 hours, for example, the toluene is drawn off under suction and the sample is weighed. After the sample has been dried under reduced pressure it is weighed again.

The swelling index is the ratio of the final mass after the swelling operation to the final dry mass after the further drying. Accordingly, the gel fraction is computed from the ratio of the final dry mass after the swelling step to the initial mass before the swelling step (×100%).

The T2 time is determined by measuring the NMR relaxation of a dewatered, filmed sample of the graft base dispersion. For this purpose, for example, the sample is dried under reduced pressure for 3 hours at 60° C., for example, after having been flashed off overnight, and then is measured with a suitable measuring instrument, e.g., a minispec from Brucker, at 80° C. Samples are comparable only if they have been measured by the same method, since relaxation is significantly temperature-dependent.

The graft b2 may be produced under the same conditions as for the production of graft base b1, and the graft b2 can be produced in one or more process steps.

In the case of a two-stage grafting, for example, first styrene or alpha-methylstyrene alone and thereafter styrene and acrylonitrile can be polymerized in two successive steps. This two-stage grafting (first styrene, then styrene/acrylonitrile) is one preferred embodiment. Further details on the preparation of the graft copolymers and of the impact modifiers b are described in DE 12 60 135 and DE 31 49 358.

It is advantageous for the graft polymerization onto the graft base b1 to be carried out in turn in aqueous emulsion. It can be performed in the same system as the polymerization of the graft base, in which case emulsifier and initiator may further be added. They need not be identical to the emulsifiers and initiators used for preparing the graft base b1. For example, it may be useful, as initiator for preparing the graft base b1, to use a persulfate, but to use a redox initiator system for the polymerization of the graft shell b2. Otherwise, the selection of emulsifier, initiator, and polymerization auxiliaries is governed by the statements made with regard to the preparation of graft base b1. The monomer mixture to be grafted on may be added to the reaction mixture all at once, in batches in two or more stages, or, preferably, continuously during the polymerization.

Where ungrafted polymers of the monomers b21) to b23) are formed during the grafting of the graft base b1, the amounts, which are in general below 10 wt % of b2, are assigned to the mass of component b.

### Component B1

Employed as component B1, a lubricant and mold release agent, is at least one, preferably one, amide of at least one, preferably one saturated higher fatty acid having 14 to 22, especially 16 to 20, carbon atoms, or an amide derivative of at least one, preferably one saturated higher fatty acid having 14 to 22, especially 16 to 20, carbon atoms.

Component B1 preferably is an amide of a saturated higher fatty acid having 16 to 20 carbon atoms or preferably an amide derivative of a saturated higher fatty acid having 16 to 20 carbon atoms. With particular preference component B1 is an amide or amide derivative of stearic or behenic acid, more particularly an amide derivative of stearic acid, very preferably ethylenebisstearylamide.

The fraction of component B1, based on the molding composition of the invention comprising the components A, B1, B2, and C, is preferably 1.5 to 3.0 wt %, more preferably component 1.7 to 2.5 wt %.

### Component B2

Employed as component B2, a lubricant and mold release agent, is at least one, preferably one, salt of at least one, preferably one, saturated higher fatty acid having 14 to 22, especially 16 to 20, carbon atoms. Component B2 is preferably a calcium, magnesium or zinc salt of a saturated higher fatty acid having 16 to 20 carbon atoms. With particular preference component B2 is a calcium, magnesium or zinc salt of stearic or behenic acid, very preferably magnesium stearate.

The fraction of component B2, based on the molding composition of the invention comprising the components A, B1, B2, and C, is preferably 0.25 to 0.5 wt %, more preferably 0.3 to 0.4 wt %.

### Auxiliaries C

As component C, the molding composition of the invention comprises one or more auxiliaries C selected from the group consisting of: stabilizers, oxidation retarders, and agents against thermal decomposition and decomposition by ultraviolent light.

Oftentimes 2 or more different auxiliaries C from those identified above are employed.

The total amount of the auxiliary C is generally 0.01 to 3 wt %, especially 0.05 to 2 wt %, more preferably 0.1 to 2 wt %, based on the molding composition of the invention composed of the components A, B1, B2, and C.

Examples of oxidation retarders and heat stabilizers are halides of the metals from group I of the periodic table, examples being sodium, potassium and/or lithium halides, optionally in combination with copper(I) halides, e.g., chlorides, bromides, iodides, sterically hindered phenols, hydroquinones, various substituted representatives of these groups, and mixtures thereof, in concentrations of up to 1 wt %.

UV stabilizers, used generally in amounts of up to 2 wt %, include various substituted resorcinols, salicylates, benzotriazoles, and benzophenones.

### Additives D

The molding composition used in accordance with the invention may further optionally comprise one or more customary additives D different from the components B1, B2, and C, such as colorants, dyes and pigments, fibrous and pulverulent fillers and reinforcing agents, nucleating agents, processing assistants, plasticizers, flame retarders, and so on, the proportion thereof being generally not more than 30 parts by weight, preferably not more than 20 parts by weight, more preferably not more than 10 parts by weight, based on 100 parts by weight of the molding composition composed of the components A, B1, B2, and C.

If there are one or more additives D in the molding composition of the invention, the minimum fraction thereof is customarily 0.01 part by weight, preferably 0.05 part by weight, more preferably 0.1 part by weight.

Furthermore, organic dyes may be added, such as nigrosine, pigments such as titanium dioxide, phthalocyanines, ultramarine blue, and carbon black as colorants, and also fibrous and pulverulent fillers and reinforcing agents. Examples of the latter are carbon fibers, glass fibers, amorphous silica, calcium silicate (wollastonite), aluminum silicate, magnesium carbonate, kaolin, chalk, powdered quartz, mica, and feldspar. The fraction of such fillers and colorants is generally up to 30 parts by weight, preferably up to 20 parts by weight, and more preferably up to 10 parts by weight.

Examples of nucleating agents that can be used are talc, calcium fluoride, sodium phenylphosphinate, aluminum oxide, silicon dioxide, and nylon 22.

For better processing, mineral-based antiblocking agents may be added in amounts up to 0.1 part by weight to the molding compositions of the invention. Examples include amorphous or crystalline silica, calcium carbonate, or aluminum silicate.

Processing assistants which can be used are, for example, mineral oil, preferably medical white oil, in amounts up to 5 parts by weight, preferably up to 2 parts by weight.

Examples of plasticizers include dioctyl phthalate, dibenzyl phthalate, butyl benzyl phthalate, hydrocarbon oils, N-(n-butyl)benzenesulfonamide, and o- and p-tolylethylsulfonamide.

For further improving the resistance to inflammation, it is possible to add all of the flame retarders known for the thermoplastics in question, more particularly those flame retarders based on phosphorus compounds and/or on red phosphorus itself.

### Production of the Molding Composition

The production of the molding compositions of the invention from the components A, B1, B2, C and optionally additives and/or auxiliaries D is another subject of the invention. It may take place by all known methods.

As regards the production of the thermoplastic molding compositions, details follow hereinafter:

The graft copolymers and/or impact modifiers b with uni-, bi- or trimodal particle size distribution are prepared by the method of emulsion polymerization, as already described above. As already described, the desired particle size distribution may be established by appropriate measures familiar to the skilled person.

The resulting dispersion of the graft copolymers b may either be mixed directly with the components a, B1, B2, C, and optionally D, or it may be worked up beforehand. The latter approach is preferred.

The dispersion of the graft copolymers b is worked up in a manner known per se. Customarily, first of all, the graft copolymer b is precipitated from the dispersion, by addition of precipitating salt solutions (such as calcium chloride, magnesium sulfate, alum) or acids (such as acetic acid, hydrochloric acid or sulfuric acid), for example, or else by freezing (freeze coagulation). The aqueous phase can be removed in a customary way, for instance by sieving, filtering, decanting or centrifuging. This prior separation of the dispersion water produces water-moist graft copolymers b having a residual water content of up to 60 wt %, based on b, in which case the residual water, for example, may adhere externally to the graft copolymer b and may also be included within it.

The graft copolymer b can subsequently, as and when required, be dried further in a known way, for example, using hot air or by means of a pneumatic dryer. It is also possible to work up the dispersion by spray drying.

The graft copolymers b are mixed with the polymer a and with the components B1, B2, C, and optionally D, in a mixing apparatus, producing a substantially liquid-melt polymer mixture.

“Substantially liquid-melt” means that the polymer mixture, as well as the predominant liquid-melt (softened) fraction, may further comprise a certain fraction of solid constituents, examples being unmelted fillers and reinforcing materials such as glass fibers, metal flakes, or else unmelted pigments, colorants, etc. “Liquid-melt” means that the polymer mixture is at least of low fluidity, therefore having softened at least to an extent that it has plastic properties.

Mixing apparatuses used are those known to the skilled person. Components a, b, B1, B2, C and—where included—D may be mixed, for example, by joint extrusion, kneading, or rolling, the aforementioned components a and b necessarily having first been isolated from the aqueous dispersion or from the solution obtained in the polymerization.

Where one or more components in the form of an aqueous dispersion or of an aqueous or nonaqueous solution are mixed in, the water and/or the solvent is removed from the mixing apparatus, preferably an extruder, via a degassing unit.

Examples of mixing apparatus for implementing the method include discontinuously operating, heated internal kneading devices with or without ram, continuously operating kneaders, such as continuous internal kneaders, screw kneaders with axially oscillating screws, Banbury kneaders, furthermore extruders, and also roll mills, mixing roll mills with heated rolls, and calenders.

A preferred mixing apparatus used is an extruder. Particularly suitable for melt extrusion are, for example, single-screw or twin-screw extruders. A twin-screw extruder is preferred.

In some cases the mechanical energy introduced by the mixing apparatus in the course of mixing is enough to cause the mixture to melt, meaning that the mixing apparatus does not have to be heated. Otherwise, the mixing apparatus is generally heated. The temperature is guided by the chemical and physical properties of components a, b, B1, B2, C and—when present—D, and should be selected such as to result in a substantially liquid-melt polymer mixture. On the other hand, the temperature is not to be unnecessarily high, in order to prevent thermal damage of the polymer mixture. The mechanical energy introduced may, however, also be high enough that the mixing apparatus may even require cooling. The mixing apparatus is operated customarily at 160 to 400, preferably 180 to 300° C.

In one preferred embodiment the mixing of the graft copolymer b with the polymer a and, where included, with the components B1, B2, C, and optionally D takes place in an extruder, with the dispersion of the graft copolymer b being metered directly into the extruder, without prior removal of the dispersion water. The water is customarily removed along the extruder via suitable degassing facilities.

Degassing facilities used may be, for example, degassing vents which are provided with retention screws (preventing the emergence of the polymer mixture).

In another, likewise preferred embodiment, the mixing of the aforementioned components takes place in an extruder, with the graft copolymer b being separated beforehand from the dispersion water. As a result of this prior removal of the dispersion water, water-moist graft copolymers b are obtained which have a residual water content of up to 60 wt %, based on b. The residual water present may then be removed in vapor form as described above via degassing facilities in the extruder. With particular preference, however, the residual water in the extruder is not removed solely as vapor; instead, a part of the residual water is removed mechanically in the extruder and leaves the extruder in the liquid phase. In the case of this so-called squeeze method (EP-B 0 993 476, pp. 13-16), the same extruder is supplied with the polymer a, the components B1, B2, C and—where present—D, meaning that the product of the method extruded is the completed molding composition.

Preference is given to a molding composition of the invention as described above, comprising (or consisting of):

A: 93.5 to 98.2 wt % of at least one impact-modified polymer A, consisting of the components a and b:
a: 50 to 88 wt %, preferably 55 to 85 wt %, of at least one styrene-acrylonitrile copolymer having an average molar mass Mw of 150 000 to 360 000 g/mol, obtained by polymerization of 18 to 35 wt %, preferably 20 to 35 wt %, more preferably 22 to 35 wt % of acrylonitrile, and 82 to 65 wt %, preferably 80 to 65 wt %, more preferably 78 to 65 wt % of styrene;
b: 50 to 12 wt %, preferably 45 to 15 wt %, of at least one graft copolymer b as impact modifier, consisting of, based on b:
   b1: 20 to 90 wt %, preferably 40 to 90 wt %, of a graft base b1, obtained by polymerization of:
      b11: 70 to 100 wt %, preferably 90 to 100 wt %, of butadiene,
      b12: 0 to 30 wt %, preferably 0 to 10 wt %, of styrene; and
   b2: 10 to 80 wt %, preferably 10 to 60 wt %, of a graft b2, obtained by polymerization of:
      b21: 65 to 95 wt %, preferably 70 to 90 wt %, more particularly 72.5 to 85 wt %, more preferably 75 to 85 wt %, of styrene;
      b22: 5 to 35 wt %, preferably 10 to 30 wt %, more particularly 15 to 27.5 wt %, often more preferably 15 to 25 wt %, of acrylonitrile;
   where the sum of a and b makes 100 wt %,
      B1: 1.5 to 3.0 wt % of an amide or amide derivative of stearic or behenic acid, more preferably ethylenebisstearylamide,
      B2: 0.25 to 0.5 wt % of a calcium, magnesium or zinc salt of stearic or behenic acid, preferably magnesium stearate; and
      C: 0.05 to 3 wt % of one or more auxiliaries C.

Particular preference is given to a molding composition of the invention, comprising (or consisting of):

A: 95.1 to 97.95 wt % of an impact-modified polymer A, consisting of the components a and b:
a: 55 to 85 wt %, preferably 65 to 85 wt %, of at least one styrene-acrylonitrile copolymer having an average molar mass Mw of 150 000 to 360 000 g/mol, obtained by polymerization of 18 to 35 wt %, preferably 20 to 35 wt %, more preferably 22 to 35 wt % of acrylonitrile, and 82 to 65 wt %, preferably 80 to 65 wt %, more preferably 78 to 65 wt % of styrene,
b: 45 to 15 wt %, preferably 35 to 15 wt %, of at least one graft copolymer b as impact modifier, consisting of, based on b:
   b1: 20 to 90 wt %, preferably 40 to 90 wt %, of a graft base b1, obtained by polymerization of:
      b11: 70 to 100 wt % of butadiene;
      b12: 0 to 30 wt % of styrene;
   b2: 10 to 80 wt %, preferably 10 to 60 wt %, of a graft b2, obtained by polymerization of:
      b21: 65 to 95 wt %, preferably 70 to 90 wt %, more particularly 72.5 to 85 wt %, more preferably 75 to 85 wt %, of styrene;
      b22: 5 to 35 wt %, preferably 10 to 30 wt %, more particularly 15 to 27.5 wt %, often more preferably 15 to 25 wt %, of acrylonitrile;
         B1: 1.7 to 2.5 wt % of an amide or amide derivative of stearic or behenic acid, more preferably ethylenebisstearylamide,
         B2: 0.3 to 0.4 wt % of a calcium, magnesium or zinc salt of stearic or behenic acid, preferably magnesium stearate; and
         C: 0.05 to 2 wt % of one or more auxiliaries C.

Further preferred are aforesaid molding compositions of the invention in which the graft base b1 has been obtained by polymerization of 100 wt % of butadiene (b11).

The viscosity of the molding composition of the invention at shear rates of 1 to 10 l/s and at temperatures of 250° C. is not higher than 1×10⁵ Pa*s, preferably not higher than 1×10⁴ Pa*s, more preferably not higher than 1×10³ Pa*s.

The melt volume rate (MVR, measured to ISO 1133-1:2011 at 220° C. and 10 kg load) is generally more than 6 ml/10 min, preferably more than 8 ml/10 min, more preferably more than 10 ml/min, very preferably more than 12 ml/min.

Another feature of the molding composition of the invention is that its residual monomer content is not more than 2000 ppm, preferably not more than 1000 ppm, more preferably not more than 500 ppm. Residual monomer content refers to the fraction of unreacted (uncopolymerized) monomers in the molding composition.

Furthermore, the molding composition of the invention features a solvent content, such as the content of ethylbenzene, toluene, etc., for example, of not more than 1000 ppm, preferably not more than 500 ppm, more preferably not more than 200 ppm.

The low residual monomer content and solvent content can be obtained by employing customary methods for reducing residual monomers and solvents from polymer melts, as described for example in Kunststoffhandbuch, Eds. R. Vieweg and G. Daumiller, vol. 4 “Polystyrol”, Carl-Hanser-Verlag Munich (1996), pp. 121 to 139. In these methods, typical degassing apparatuses, such as, for example, partial evaporators, flat evaporators, strand devolatilizers, thin-film evaporators or devolatilizing extruders, for example, are used. As a result of the low residual monomer content and also solvent content, the molding composition of the invention is low in odor and is therefore outstandingly suitable for 3D printers in the home-use segment, and also for 3D printers employed industrially.

Furthermore, the molding composition contains not more than 500 ppm, preferably not more than 400 ppm, more preferably not more than 300 ppm of transition metals such as Fe, Mn, and Zn, for example. Molding compositions with a low level of transition metals of this kind can be obtained, for example, by using redox initiators—if used to initiate the polymerization of the polymers present in the molding composition—only in small amounts in combination with peroxides. Furthermore, therefore, there ought to be only small amounts of transition metal-containing minerals (e.g., pigments) present in the molding composition.

The molding compositions of the invention exhibit an optimized toughness/viscosity balance and are therefore outstandingly suitable for 3D printing, and are used in accordance with the invention for producing three-dimensional objects of predetermined shape by means of a device for 3D printing. A further subject of the invention is therefore the use of the molding compositions of the invention for 3D printing.

It is possible here to use customary apparatuses suitable for 3D printing, especially 3D printers for home use. Likewise suitable are 3D printers for the industrial sphere.

An advantage for the home-use sector and also for the industrial application sphere is that the molding composition is of low odor, having only a low residual monomer content and also solvent content.

The three-dimensional object is generally built up under computer control from the fluidized molding composition of the invention, according to mandated dimensions and shapes (CAD).

The three-dimensional object can be produced using customary methods of 3D printing in accordance with the prior art as described for example in EP 1015215 B1 and in US 2009/0295032 A1.

Customarily, first of all, the molding composition of the invention is fluidized and extruded, a plurality of layers of the molding composition are applied to a base such as a support or to a preceding layer of the molding composition, and then the shaped material is consolidated by cooling below the solidification temperature of the molding composition.

Preference is given to the use of the molding composition in 3D printers which are suitable for the fused deposition modeling (FDM) method.

A further subject of the invention is a method for producing 3-dimensional moldings from the molding composition of the invention, where in a 3D printer with a heating nozzle freely movable in the fabrication plane, a supplied filament of the molding composition of the invention is fluidized, and the fluidized molding composition is extruded, applied layer by layer, by means of the fused deposition modeling method, and consolidated, optionally by cooling. The nozzle temperature is generally 200 to 270° C., preferably 230 to 250° C., especially 240° C.

A further subject of the invention is the use of the molding compositions of the invention for producing filaments having high dimensional stability for 3D printing. The filaments obtained by customary methods (e.g., extrusion) from the molding compositions of the invention have a high dimensional stability.

A high dimensional stability of a filament for 3D printing means, for the purposes of the present invention, that the resulting average diameter of the filament deviates from the setpoint diameter of the filament by at most +/−0.045 mm, preferably at most +/−0.035 mm, more preferably at most +/−0.025 mm and the ovality of the filament is <0.03 mm, preferably <0.02 mm, very preferably ≤0.015 mm. The setpoint diameter selected for the filament is preferably a diameter of 1.50 to 3.20 mm, and more preferably it is 1.70 to 1.80 or 2.80 to 3.00, very preferably 1.75 to 1.80 mm or 2.85 to 3.00.

The invention is particularized by the present examples and claims.

### EXAMPLES

Employed as polymer a were the following copolymers:

a1: SAN copolymer with 73 wt % styrene and 27 wt % acrylonitrile (=S/AN 73/27), MVR (220° C./10′): 55 ccm/10 min
a5: SAN copolymer (S/AN 65/35), MVR (220° C./10′): 61 ccm/10 min

The MVR was determined according to ISO 1133 at 220° C. with 10 kg load.

Employed as impact modifier b with a trimodal particle size distribution was a mixture of ABS graft copolymers b′, b″, and b′″ with different particle diameters, the fraction of the ABS graft copolymers b″ and b′″ (weight ratio b″:b′″=50:50) in the mixture together being 60 wt %, and the fraction of ABS graft copolymer b′ being 40 wt %.

Preparation of ABS Graft Copolymers b″ and b′″

29 parts by weight (reckoned as solid) of an anionically emulsified polybutadiene latex (b1″) which is prepared using a polybutadiene seed latex having an average particle diameter d₅₀ of 111 nm via radical seed polymerization and which has an average particle diameter d₅₀ of 305 nm and a gel content of 55 wt % and 29 parts by weight (reckoned as solid) of an anionically emulsified polybutadiene latex (b1′″) which is prepared using a polybutadiene seed latex having an average particle diameter d₅₀ of 137 nm via radical seed polymerization and which has an average particle diameter d₅₀ of 404 nm and a gel content of 81 wt % are brought with water to a solids content of approximately 20 wt %, then heated to 59° C. and admixed with 0.5 part by weight of potassium peroxodisulfate (in solution in water).

Thereafter 42 parts by weight of a mixture of 73 wt % styrene, 27 wt % acrylonitrile, and 0.12 part by weight of tert-dodecyl mercaptan are metered in at a uniform rate over the course of 6 hours; in parallel with this, 1 part by weight (reckoned as solid material) of the sodium salt of a resin acid mixture (Dresinate 731, Abieta Chemie GmbH, Gersthofen, Germany, in solution in alkalified water) is metered in over a period of 6 hours. Over the course of the 6 hours, the reaction temperature is raised from 59° C. to 80° C. After a two-hour afterreaction time at 80° C., the graft latex (b″ and b′″), following addition of about 1.0 part by weight of a phenolic antioxidant, is coagulated using a magnesium sulfate/acetic acid mixture, and, after washing with water, the resulting wet powder is dried at 70° C.

Preparation of ABS Graft Copolymer b′

50 parts by weight (reckoned as solid) of an anionically emulsified polybutadiene latex which is prepared using a polybutadiene seed latex having an average particle diameter d₅₀ of 48 nm via radical seed polymerization and which has an average particle diameter d₅₀ of 137 nm and a gel content of 88 wt % are brought with water to a solids content of approximately 20 wt %, then heated to 59° C. and admixed with 0.5 part by weight of potassium peroxodisulfate (in solution in water).

Thereafter 50 parts by weight of a mixture of 73 wt % styrene, 27 wt % acrylonitrile, and 0.15 part by weight of tert-dodecyl mercaptan are metered in at a uniform rate over the course of 6 hours; in parallel with this, 1 part by weight (reckoned as solid material) of the sodium salt of a resin acid mixture (Dresinate 731, Abieta Chemie GmbH, Gersthofen, Germany, in solution in alkalified water) is metered in over a period of 6 hours. Over the course of the 6 hours, the reaction temperature is raised from 59° C. to 80° C. After a two-hour afterreaction time at 80° C., the graft latex, following addition of about 1.0 part by weight of a phenolic antioxidant, is coagulated using a magnesium sulfate/acetic acid mixture, and, after washing with water, the resulting wet powder is dried at 70° C.

Lubricants and Mold Release Agents B

B1: distearylethylenediamide wax (EBS), Acrawax® C from Lonza
B2: magnesium stearate (Mg)

### Additives C

C1: Irganox® 1076 from Ciba Inc., oxidation retarder and heat stabilizer
C2: Irganox® PS802 from BASF SE, heat stabilizer

### Production of the Molding Compositions

The above-described polymer components a and b are mixed in the proportions indicated in table 1, with addition of components C1 and C2 and also optionally B1 and/or B2, in a twin-screw extruder at 200 to 250° C., and the mixture is processed to a molding composition. Molding compositions 1 to 4 are inventive; molding compositions C1 to C6 are comparative examples.

TABLE 1
Formulation of molding composition

| | Molding composition (MC) | | | | | | | | | |
|---|---|---|---|---|---|---|---|---|---|---|
| | 1 | 2 | 3 | 4 | C1 | C2 | C3 | C4 | C5 | C6 |
| b (wt %, based | 15 | 15 | 30 | 30 | 15 | 15 | 30 | 30 | 30 | 30 |
| on A) | | | | | | | | | | |
| a1 (wt %, based | 85 | | 70 | | 85 | | 70 | | 70 | 70 |
| on A) | | | | | | | | | | |
| a5 (wt %, based | | 85 | | 70 | | 85 | | 70 | | |
| on A) | | | | | | | | | | |
| A (wt %, based | 97.2 | 97.2 | 97.2 | 97.2 | 99.5 | 99.5 | 99.5 | 99.5 | 97.5 | 99.2 |
| on total MC | | | | | | | | | | |
| B1 (wt %, based | 2 | 2 | 2 | 2 | | | | | 2 | |
| on total MC) | | | | | | | | | | |
| B2 (wt %, based | 0.3 | 0.3 | 0.3 | 0.3 | | | | | | 0.3 |
| on total MC) | | | | | | | | | | |
| C1 (wt %, based | 0.2 | 0.2 | 0.2 | 0.2 | 0.2 | 0.2 | 0.2 | 0.2 | 0.2 | 0.2 |
| on total MC) | | | | | | | | | | |
| C2 (wt %, based | 0.3 | 0.3 | 0.3 | 0.3 | 0.3 | 0.3 | 0.3 | 0.3 | 0.3 | 0.3 |
| on total MC) | | | | | | | | | | |

Filaments with a setpoint diameter of 1.78 mm are produced from the resulting molding composition using a single-screw extruder with gear pump, with a nozzle which is diverted downward by 90° and has a nozzle diameter of 2 mm, in a water bath heated at 85° C., with a temperature profile of 210 to 225° C. The quality of the filaments in terms of dimensional consistency was investigated by means of a three-axis laser measuring head for the in-line measurement of the diameter and of the ovality (table 2).

TABLE 2
Filament quality

| | | | Maximum | |
|---|---|---|---|---|
| | | | deviation | |
| | Polymer a | Mean | in | |
| Molding | (MVR/AN | diameter | diameter | Ovality |
| composition | wt %) | DM (mm) | DM (mm) | (mm) |
| 1 | a1 (55/27) | 1.782 | 0.022 | 0.024 |
| 2 | a5 (61/35) | 1.783 | 0.027 | 0.017 |
| 3 | a1 (55/27) | 1.781 | 0.021 | 0.013 |
| 4 | a5 (61/35) | 1.780 | 0.020 | 0.011 |
| C1 | a1 (55/27) | 1.780 | 0.038 | 0.027 |
| C2 | a5 (61/35) | 1.780 | 0.036 | 0.026 |
| C3 | a1 (55/27) | 1.780 | 0.028 | 0.027 |
| C4 | a5 (61/35) | 1.780 | 0.034 | 0.020 |
| C5 | a1 (55/27) | 1.783 | 0.038 | 0.021 |
| C6 | a1 (55/27) | 1.781 | 0.032 | 0.016 |

### Results of the Investigation of Filament Quality

Table 2 shows that with the molding compositions 1 to 4 of the invention, owing to the combined use of the lubricant and mold release agents B1 and B2, it is possible to obtain very high levels of dimensional integrity on the part of the filaments (DM=1.78 mm+/−0.025 mm, ovality <0.02 mm with virtually all mixtures). With regard to the deviation in diameter, a synergistic effect is recognizable for the molding compositions of the invention, owing to the combined use of the lubricant and mold release agents B1 and B2, in comparison to the molding compositions C5 (component B1 only) and C6 (component B2 only).

The best results in terms of dimensional consistency (maximum deviation in diameter <=+/−0.021 mm, maximum ovality <=0.013 mm) are obtained with the molding compositions 3 and 4, which contain 30 wt % of the ABS graft copolymer (component b), 2 wt % of ethylenebisstearylamide (B1), and 0.3 wt % of magnesium stearate (B2). The greatest dimensional consistency (maximum deviation in diameter 0.020 mm, maximum ovality 0.011 mm) is achieved with molding composition 4, containing 30 wt % of ABS graft copolymer (component b), 70 wt % of component a5, 2 wt % of ethylenebisstearylamide (B1), and 0.3 wt % of magnesium stearate (B2).

### Investigation of Print Quality

FDM experiments with filaments made from the molding compositions of table 1

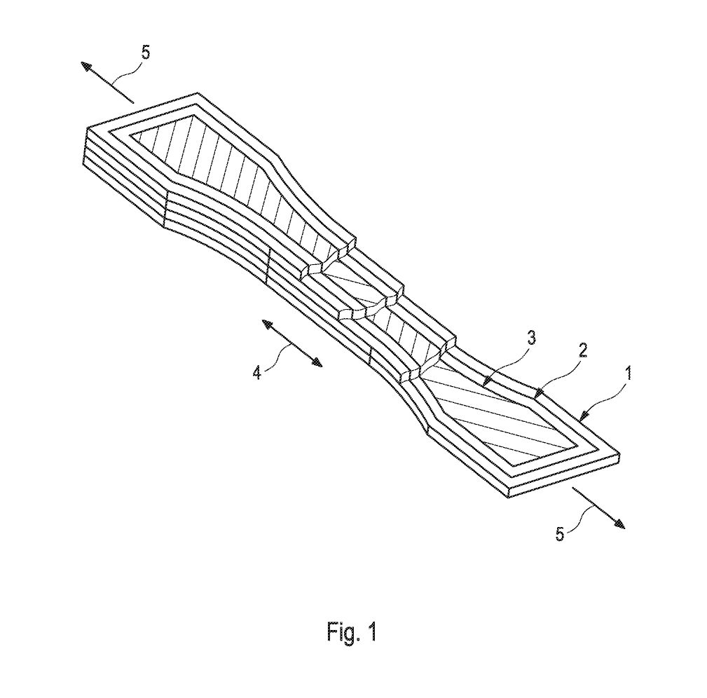

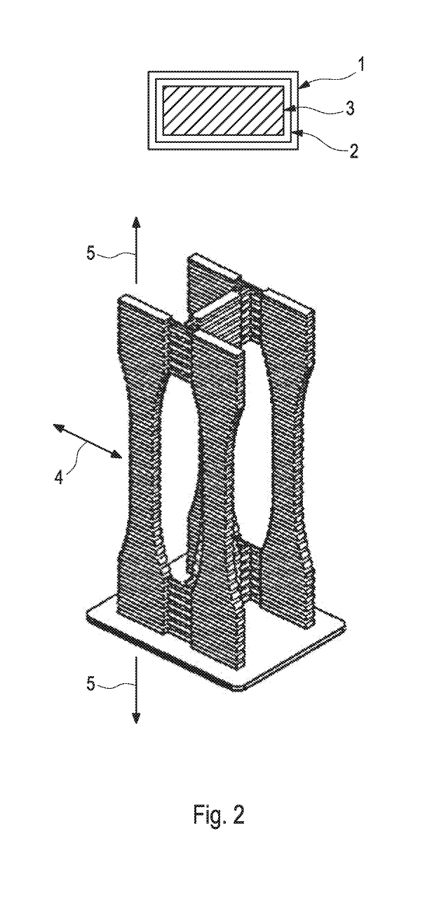

TABLE 3

| 3D printer | Reconstruction based on Ultimaker 1 | |
|---|---|---|
| Slicer | CuraEngine | |
| Interface | Pronterface | |
| Nozzle diameter | 0.4 | mm |
| Nozzle temperature | 240° | C. |
| Printing bed | aluminum + polyimide (Kapton) | |
| Printing bed temperature | setpoint 135° C., actual 120° C. | |
| Building space temperature | about 40° C. to 55° C. | |
| Sample form | DIN EN ISO 527 Type 1B tensile bars, | |
| | shortened centrally by 30 mm | |
| | 1 outer contour | |
| | 1 inner contour | |
| | filling: 100%, 45° alternately | |
| Layer thickness | 0.254 | mm |
| Printing speed | 60 | mm/s |

| | |
|---|---|
| Building orientation 1 | Horizontal |
| Tensile bars | Layers parallel to direction of tension, |
| | strands in the filling 45° to the direction of |
| | tension as per FIG. 1 |
| Building orientation 1 | Horizontal |
| Tensile bars | Arrangement of 5 tensile bars as per FIG. 2 |
| | Layers 90° to the direction of tension |

FIG. 1 shows a horizontal tensile bar; arrow (1) shows the outer contour, arrow (2) shows the inner contour, arrows (3) show the 45°, alternating filling, arrow (4) shows the layer direction, and arrows (5) show the direction of tension.

FIG. 2 shows a vertical component; an arrangement (two tensile bars in each case parallel to one another, one tensile bar offset by 90° and centered in the middle relative thereto) of five tensile bars joined to one another via the bar ends. Arrow (1) shows the outer contour, arrow (2) shows the inner contour, arrow (3) shows the 45°, alternating filling, arrow (4) shows the layer direction, and arrows (5) show the direction of tension.

The FDM method was used to produce vertical and horizontal tensile bars as per FIGS. 1 and 2 from the molding compositions of table 1. The conditions of production can be seen in table 3. To assess the printing quality, the adhesion of plies or of layers (tensile strength of tensile bars printed vertically), the tensile strength (of tensile bars printed horizontally), and the elongation at break (of tensile bars printed horizontally and vertically) were determined in accordance with DIN EN ISO 527-1:2012 (see table 4). The tensile tests were conducted on a Z010 universal testing machine from Zwick/Roell, with a contact extensometer for determining elongation, a 10 kN load cell, and at a testing velocity of 5 mm/min.

TABLE 4

| | | | Elongation at break of |
|---|---|---|---|
| | Layer | Tensile | tensile bars printed |
| Molding | adhesion | strength | horizontally/vertically |
| composition | (MPa) | (MPa) | (%) |
| 1 | 9.66 | 45.18 | 6/0.4 |
| 2 | 15.36 | 47.75 | 6.07/0.65 |
| 3 | 15.67 | 36.19 | 7.16/0.88 |
| 4 | 15.45 | 36.61 | 7.59/0.85 |
| C1 | 10.3 | 40.22 | 7.11/0.42 |
| C2 | 13.32 | 43.93 | 7.81/0.52 |
| C3 | 11.82 | 35.09 | 7.22/0.63 |
| C4 | 13.46 | 36.83 | 7.17/0.7 |
| C5 | 17.05 | 37.82 | 8.13/0.94 |
| C6 | 14.79 | 36.78 | 7.74/0.81 |

### Results:

The printing quality of the tensile bars printed from the thermoplastic materials comprising the molding compositions of the invention is good. All of the tensile bars printed from the molding compositions of the invention have mechanical properties which are satisfactory for the applications.

1-14. (canceled)

15. A thermoplastic molding composition for 3D printing, comprising a mixture of the components A, B1, B2, and C:
A: 92.9 to 98.59 wt % of at least one impact-modified polymer A, consisting of the components a and b:
a: 40 to 90 wt % of at least one vinylaromatic copolymer a having an average molar mass Mw of 150 000 to 360 000 g/mol, selected from the group consisting of: styrene-acrylonitrile copolymers, α-methylstyrene-acrylonitrile copolymers, styrene-maleic anhydride copolymers, styrene-phenylmaleimide copolymers, styrene-methyl methacrylate copolymers, styrene-acrylonitrile-maleic anhydride copolymers, styrene-acrylonitrile-phenylmaleimide copolymers, α-methylstyrene-acrylonitrile-methyl methacrylate copolymers, α-methylstyrene-acrylonitrile-tert-butyl methacrylate copolymers, and styrene-acrylonitrile-tert-butyl methacrylate copolymers; and
b: 10 to 60 wt % of at least one graft copolymer b as impact modifier, consisting of, based on b:
b1: 20 to 90 wt % of a graft base b1, obtained by polymerization of:
b11: 70 to 100 wt % of at least one conjugated diene;
b12: 0 to 30 wt % of at least one further comonomer selected from: styrene, α-methylstyrene, acrylonitrile, methacrylonitrile, MMA, MAn, and N-phenylmaleimide (N-PMI); and
b13: 0 to 10 wt % of one or more polyfunctional, crosslinking monomers;
b2: 10 to 80 wt % of a graft b2, obtained by polymerization of:
b21: 65 to 95 wt %, preferably 70 to 90 wt %, of at least one vinylaromatic monomer, preferably styrene and/or α-methylstyrene;
b22: 5 to 35 wt %, preferably 10 to 30 wt %, of acrylonitrile and/or methacrylonitrile; and
b23: 0 to 30 wt %, preferably 0 to 20 wt %, of at least one further monoethylenically unsaturated monomer selected from: MMA, MAn, and N-PMI;
where the sum of a and b makes 100 wt %,
B1: 1.2 to 3.5 wt % of at least one amide or amide derivative of at least one saturated higher fatty acid having 14 to 22, preferably 16 to 20, carbon atoms;
B2: 0.2 to 0.6 wt % of at least one salt of a saturated higher fatty acid having 14 to 22, preferably 16 to 20, carbon atoms; and
C: 0.01 to 3 wt % of one or more auxiliaries C selected from the group consisting of: stabilizers, oxidation retarders, and agents against thermal decomposition and decomposition by ultraviolet light;
where the sum of components A, B1, B2, and C makes 100 wt %.

16. The molding composition as claimed in claim 15, comprising additionally (based on 100 parts by weight of the molding composition consisting of the components A, B1, B2, and C) 0.01 to 30 parts by weight of one or more customary additives and/or auxiliaries D different from the components B1, B2, and C.

17. The molding composition as claimed in claim 15, characterized in that the viscosity thereof (measured to ISO 11443:2014) at shear rates of 1 to 10 l/s and at temperatures of 250° C. is not higher than 1×10⁵ Pa*s and the melt volume rate thereof (MVR, measured to ISO 1133-1:2011 at 220° C. and 10 kg load) is more than 6 ml/10 min.

18. The molding composition as claimed in claim 15, characterized in that the vinylaromatic copolymer a is a styrene-acrylonitrile copolymer obtained by polymerization of 18 to 35 wt % of acrylonitrile (AN) and 82 to 65 wt % of styrene (S).

19. The molding composition as claimed in claim 15, characterized in that the graft copolymer b is composed of:
b1: 40 to 90 wt % of a graft base b1, obtained by polymerization of:
b11: 70 to 100 wt %, preferably 90 to 100 wt %, of butadiene, and
b12: 0 to 30 wt %, preferably 0 to 10 wt %, of styrene; and
b2: 10 to 60 wt % of a graft b2, obtained by polymerization of:
b21: 65 to 95 wt %, preferably 70 to 90 wt %, of styrene, and
b22: 5 to 35 wt %, preferably 10 to 30 wt %, of acrylonitrile.

20. The molding composition as claimed in claim 15, characterized in that in the impact-modified polymer A, the fraction of component a is 55 to 85 wt %, preferably 65 to 85 wt %, and the fraction of the impact modifier b is 45 to 15 wt %, preferably 35 to 15 wt %.

21. The molding composition as claimed in claim 15, comprising:
93.5 to 98.2 wt % of component A,
1.5 to 3.0 wt % of component B1,
0.25 to 0.5 wt % of component B2, and
0.05 to 3 wt % of component C.

22. The molding composition as claimed in claim 15, comprising:
95.1 to 97.95 wt % of component A,
1.7 to 2.5 wt % of component B1,
0.3 to 0.4 wt % of component B2, and
0.05 to 2 wt % of component C.

23. The molding composition as claimed in claim 15, characterized in that B1 is an amide or amide derivative of stearic or behenic acid, preferably ethylenebisstearylamide, and B2 is a calcium, magnesium, or zinc salt of stearic or behenic acid, preferably magnesium stearate.

24. The molding composition as claimed in claim 15, characterized in that the graft copolymer b has an average particle size (d₅₀) of 80 to 1000 nm, preferably 85 to 600 nm.

25. The molding composition as claimed in claim 15, characterized in that the impact modifier b has a trimodal particle size distribution and is a mixture of ABS graft copolymers b′, b″, and b′″, where the graft base b1′ of the ABS graft copolymer b′ has an average particle diameter d₅₀ of 25 to 200 nm, the graft base b1″ of the ABS graft copolymer b″ has an average particle diameter d₅₀ of 230 to 330 nm, and the graft base b1′″ of the ABS graft copolymer b′″ has an average particle diameter d₅₀ of 340 to 480 nm.

26. A method of using the thermoplastic molding composition as claimed in claim 15 for 3D printing.

27. A method of using the thermoplastic molding composition as claimed in claim 15 for producing filaments for 3D printing.

28. A method for producing a thermoplastic molding composition as claimed in claim 15, by mixing the components A, B1, B2, C, and optionally additives and/or auxiliaries D.
